(19) United States
(12) Patent Application Publication
(10) Pub. No.: US 2025/0071623 A1
(43) Pub. Date: Feb. 27, 2025

(54) CELL SWITCHING METHOD AND USER EQUIPMENT

(71) Applicant: MediaTek Singapore Pte. Ltd., Singapore (SG)

(72) Inventors: Xin LI, Beijing (CN); Fengyu CHE, Beijing (CN); Zhipeng FENG, Beijing (CN); Guangpu WANG, Beijing (CN); Hongwei ZHANG, Beijing (CN); Zhen ZOU, Beijing (CN); Pan GAO, Beijing (CN); Quanping WANG, Beijing (CN)

(21) Appl. No.: 18/475,350

(22) Filed: Sep. 27, 2023

(30) Foreign Application Priority Data
Aug. 23, 2023 (CN) 202311069711.X

(51) Int. Cl. H04W 36/00; H04W 36/30

(52) U.S. Cl. CPC H04W 36/0022; H04W 36/302

(57) ABSTRACT

A method for cell selection is provided. The cell switching method may include the following steps. The UE may determine whether a serving cell is a platform cell or a tunnel cell. Then, the UE may determine whether to restrain from switching to a neighbor cell based on at least one parameter associated with the serving cell in response to the serving cell being the platform cell or the tunnel cell.

### CROSS REFERENCE TO RELATED APPLICATIONS

This application claims the benefits of CN Patent Application No. 202311069711.X filed on Aug. 23, 2023, the entirety of which is incorporated by reference herein.

### BACKGROUND OF THE INVENTION

### Field of the Invention

The invention generally relates to mobile communications, and more particularly, to a cell switching technology in the subway.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In conventional communication technology, a cell with more multi-input multi-output (MIMO) layers (e.g., 8 transmission antennas and 8 reception antennas (8T8R)) may be configured (i.e., high-throughput cells may be configured), and a cell with fewer multi-input multi-output (MIMO) layers (e.g., 2T2R) may be configured (i.e., power-saving cells may be configured). However, when a UE is in a subway, the UE may be in different communication environments, e.g., platform and tunnel. The UE may need to camp on a suitable cell to meet different requirements for different communication environments.

Therefore, how to perform cell switching more flexibly and efficiently in a subway to find a suitable cell for the UE is a topic that is worthy of discussion.

### BRIEF SUMMARY OF THE INVENTION

A cell switching method and user equipment (UE) for cell switching are provided to overcome the problems mentioned above.

An embodiment of the invention provides a cell switching method. The cell switching method may comprise the following steps. The UE may determine whether a serving cell is a platform cell or a tunnel cell. Then, the UE may determine whether to restrain from switching to a neighbor cell based on at least one parameter associated with the serving cell in response to the serving cell being the platform cell or the tunnel cell.

In some embodiments, in the cell switching method, the UE may further determine that the serving cell is the platform cell in response to the number of multi-input multi-output (MIMO) layers being higher than a first value, a synchronization signal (ss)-physical broadcast channel (PBCH)-BlockPower being lower than or equal to 5 and the serving cell having a lower variance.

In some embodiments, in the cell switching method, the UE may further determine that the serving cell is the tunnel cell in response to the number of MIMO layers being lower than or equal to the first value, the ss-PBCH-BlockPower being higher than or equal to 0 and the serving cell having a higher variance.

In some embodiments, in the cell switching method, the serving cell having a lower variance may mean that the reference signal received power (RSRP) variance (VAR) of the serving cell is smaller than a first threshold and the Doppler value of the serving cell is smaller than a second threshold, and wherein the serving cell having a higher variance may mean that the RSRP VAR of the serving cell is larger than a third threshold and the Doppler value of the serving cell is larger than a fourth threshold.

In some embodiments, in the cell switching method, the UE may further determine that the UE enters a subway mode in response to the serving cell being switched to the platform cell or the tunnel cell, and determine that the UE leaves the subway mode in response to the serving cell being switched to a cell from the platform cell or the tunnel cell, wherein the cell is not the platform cell or the tunnel cell.

In some embodiments, in the cell switching method, the at least one parameter may comprise the number of MIMO layers, a carrier bandwidth, an ss-PBCH-BlockPower, an RSRP, a signal-to-interference-plus-noise ratio (SINR), and a reception (Rx) quality level.

In some embodiments, in the cell switching method, the UE may further restrain from switching from the platform cell to the neighbor cell when at least one condition is met, wherein the at least one condition comprises that the number of MIMO layers is higher than or equal to a first value, the carrier bandwidth is equal to a second value, the ss-PBCH-BlockPower is higher than a third value, the RSRP exceeds a first threshold, the SINR exceeds a second threshold, and the Rx quality level exceeds a third threshold.

In some embodiments, in the cell switching method, the UE may further restrain from switching from the tunnel cell to the neighbor cell when at least one condition is met, wherein the at least one condition comprises that the neighbor cell is another tunnel cell, the number of MIMO layers is higher than or equal to the first value, the RSRP exceeds a first threshold, and the SINR exceeds a second threshold.

In some embodiments, in the cell switching method, the UE may further set a threshold for an RSRP difference between the serving cell and the neighbor cell, or set an offset of the neighbor cell to restrain from switching to the neighbor cell.

In some embodiments, in the cell switching method, the UE may further determine whether the neighbor cell is the platform cell in response to the serving cell being the tunnel cell, and switch the serving cell to the neighbor cell in response to the neighbor cell being the platform cell.

An embodiment of the invention provides a user equipment (UE) for cell switching. The UE may comprise a processor. The processor may determine whether a serving cell is a platform cell or a tunnel cell, and determine whether to restrain from switching to a neighbor cell based on at least one parameter associated with the serving cell in response to the serving cell being the platform cell or the tunnel cell.

Other aspects and features of the invention will become apparent to those with ordinary skill in the art upon review of the following descriptions of specific embodiments of the method and UE for cell switching.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a flow chart illustrating a method 200 for determining the type of the serving cell according to an embodiment of the invention.

FIG. 3 is a flow chart illustrating a method 300 for restraining from switching to a neighbor cell according to an embodiment of the invention.

FIG. 4 is a flow chart illustrating a method 400 for restraining from switching to a neighbor cell according to another embodiment of the invention.

FIG. 5 is a flow chart illustrating a method 500 for switching from a tunnel cell to a platform cell according to an embodiment of the invention.

FIG. 6 is a flow chart illustrating a cell switching method 600 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

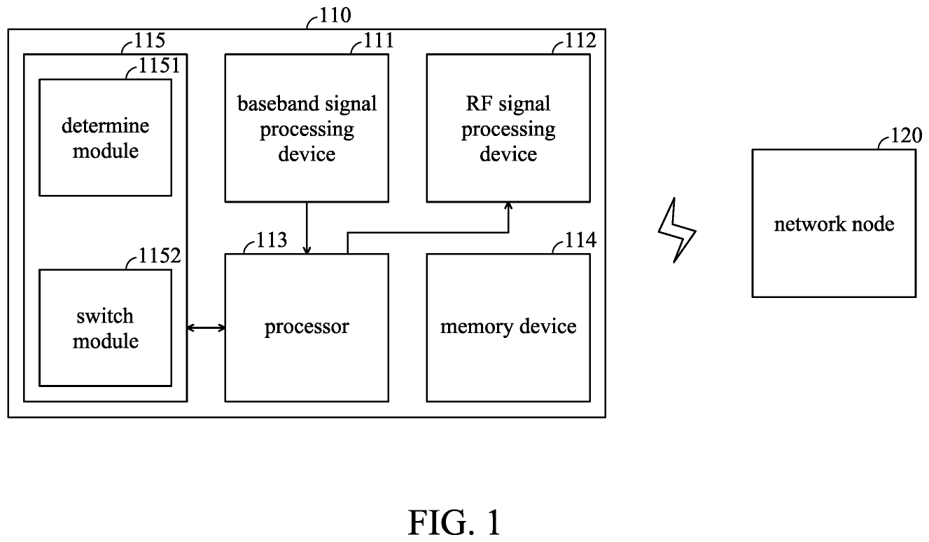

FIG. 1 is a block diagram of a wireless communications system 100 according to an embodiment of the invention. As shown in FIG. 1, the wireless communications system 100 may comprise user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments, the network node 120 may be a base station, a gNodeB (gNB), a NodeB (NB) an eNodeB (eNB), an access point, an access terminal, but the invention should not be limited thereto. In the embodiments, the UE 110 may communicate with the network node 120 through the fourth generation (4G) communication technology, fifth generation (5G) communication technology, but the invention should not be limited thereto.

As shown in FIG. 1, the UE 110 may comprise at least a baseband signal processing device 111, a radio frequency (RF) signal processing device 112, a processor 113, a memory device 114, and function modules and circuits 115. The network node 120 may comprise similar devices or elements as UE 110.

In the embodiments of the invention, the UE 110 may be a smartphone, Personal Data Assistant (PDA), pager, laptop computer, desktop computer, wireless handset, or any computing device that includes a wireless communications interface.

The RF signal processing device 112 may be a transceiver. The RF signal processing device 112 may comprise a plurality of antennas to receive or transmit RF signals. The RF signal processing device 112 may receive RF signals via the antennas and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, analog-to-digital converter (ADC)/digital-to-analog converter (DAC), etc.

The baseband signal processing device 111 may further process the baseband signals to obtain information or data transmitted by the peer communications apparatus. The baseband signal processing device 111 may also comprise a plurality of hardware elements to perform baseband signal processing.

The processor 113 may control the operations of the baseband signal processing device 111, the RF signal processing device 112, the memory device 114 and the function modules and circuits 115. According to an embodiment of the invention, the processor 113 may also be arranged to execute the program codes of the software modules of the corresponding baseband signal processing device 111, the RF signal processing device 112 and the function modules and circuits 115. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software modules.

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

The function modules and circuits 115 may comprise a determine module 1151 and a switch module 1152. The processor 113 may execute different modules or circuits in the function modules and circuits 115 to perform embodiments of the present invention. In the embodiment of the invention, the determine module 1151 may determine whether a serving cell is a platform cell or a tunnel cell and determine whether to restrain the serving cell from switching to a neighbor cell based on at least one parameter associated with the serving cell when the serving cell is a platform cell or a tunnel cell. The switch module 1152 may switch the serving cell to a suitable cell.

According to an embodiment of the invention, the baseband signal processing device 111 and the RF signal processing device 112 may be configured in a modem (MD) of the UE 110, and the processor 113 may be configured in an application processor (AP) of the UE 110. According to an embodiment of the invention, the function modules and circuits 115 may be configured in the modem or AP of the UE 110.

According to an embodiment of the invention, the UE 110 may determine whether a serving cell is a platform cell or a tunnel cell. In addition, when the serving cell is a platform cell or a tunnel cell, the UE 110 may determine whether to restrain the serving cell from switching to a neighbor cell based on at least one parameter associated with the serving cell. According to an embodiment of the invention, when the serving cell is a platform cell or a tunnel cell, it is defined that the UE 110 is in a subway mode.

According to an embodiment of the invention, the parameter(s) associated with the serving cell may comprise the number of multi-input multi-output (MIMO) layers, a carrier bandwidth, a synchronization signal (ss)-physical broadcast channel (PBCH)-BlockPower, an RSRP, a signal-to-interference-plus-noise ratio (SINR), a reception (Rx) quality level, or any combination thereof. The parameters may be configured by the network node 120.

According to an embodiment of the invention, the UE 110 may determine that the serving cell is a platform cell when at least one condition is met. In an example, the UE 110 may determine that the serving cell is the platform cell when the number of MIMO layers is higher than a value (e.g., 2, i.e., 2 transmission antennas and 2 reception antennas (2T2R)), the ss-PBCH-BlockPower is lower than or equal to 5, and the serving cell has a lower variance, but the invention should not be limited thereto. In an embodiment, the serving cell having a lower variance may mean that the reference signal received power (RSRP) variance (VAR) of the serving cell is smaller than a threshold (e.g., 7) and the Doppler value of the serving cell is smaller than a threshold (e.g., 0). That is, the UE 110 may be in a static environment (e.g., the platform of subway).

According to an embodiment of the invention, the UE 110 may determine that the serving cell is a tunnel cell when at least one condition is met. In an example, the UE 110 may determine that the serving cell is the tunnel cell when the number of MIMO layers is lower than or equal to a value (e.g., 2), the ss-PBCH-BlockPower is higher than or equal to 0, and the serving cell has a higher variance. In an embodiment, serving cell has a higher variance means that the RSRP VAR of the serving cell is larger than a threshold (e.g., 7) and the Doppler value of the serving cell is larger than a threshold (e.g., 0). That is, the UE 110 may be in a moving environment (e.g., the tunnel of subway).

When the UE 110 determines that the serving cell is not a platform cell and a tunnel cell. The UE 110 may perform normal cell switching specified in the standard.

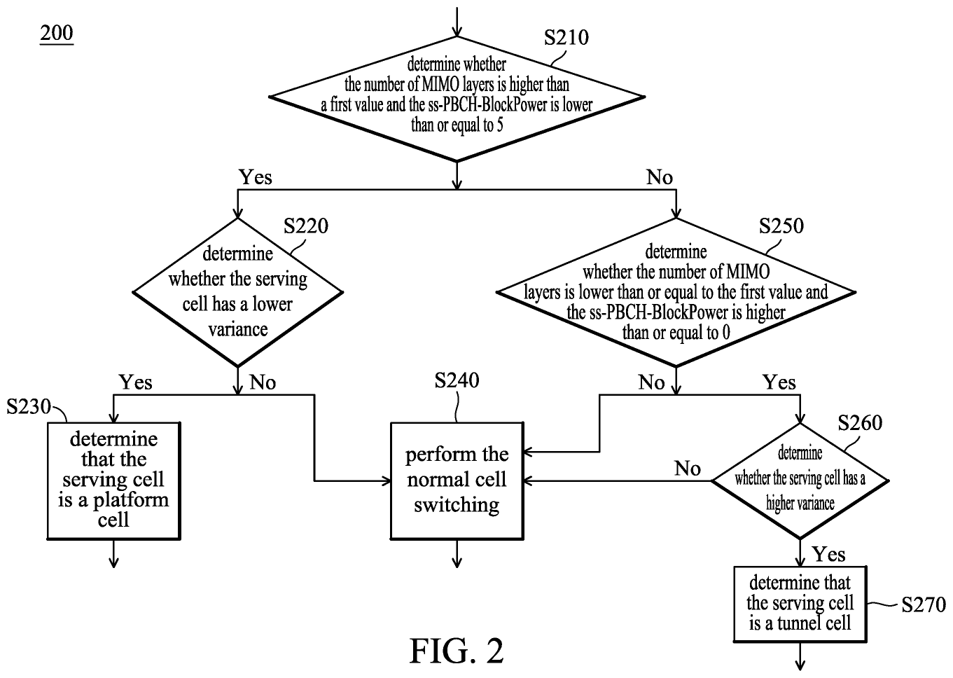

FIG. 2 is a flow chart illustrating a method 200 for determining the type of the serving cell according to an embodiment of the invention. The method 200 may be applied to UE 110. As shown in FIG. 2, in step S210, the UE 110 may determine whether the number of MIMO layers is higher than a first value (e.g., 2) and the ss-PBCH-BlockPower is lower than or equal to 5.

If the number of MIMO layers is higher than the first value (e.g., 2) and the ss-PBCH-BlockPower is lower than or equal to 5, step S220 is performed. In step S220, the UE 110 may determine whether the serving cell has a lower variance.

If the serving cell has a lower variance, step S230 is performed. In step S230, the UE 110 may determine that the serving cell is a platform cell. If the serving cell does not have a lower variance, step S240 is performed. In step S240, the UE 110 may perform the normal cell switching.

If the number of MIMO layers is not higher than the first value (e.g., 2) and the ss-PBCH-BlockPower is not lower than or equal to 5, step S250 is performed. In step S250, the UE 110 may determine whether the number of MIMO layers is lower than or equal to the first value (e.g., 2) and the ss-PBCH-BlockPower is higher than or equal to 0.

If the number of MIMO layers is lower than or equal to the first value (e.g., 2) and the ss-PBCH-BlockPower is higher than or equal to 0, step S260 is performed. In step S260, the UE may determine whether the serving cell has a higher variance. If the number of MIMO layers is not lower than or equal to the first value (e.g., 2) and the ss-PBCH-BlockPower is not higher than or equal to 0, step S240 is performed.

If the serving cell has a higher variance, step S270 is performed. In step S270, the UE 110 may determine that the serving cell is a tunnel cell. If the serving cell does not has a higher variance, step S240 is performed.

According to an embodiment of the invention, the UE 110 may determine that the UE 110 will enter a subway mode when the serving cell is switched from a cell to a platform cell or a tunnel cell. In addition, the UE 110 may determine that the UE 110 will leave the subway mode when the serving cell is switched from the platform cell or the tunnel cell to a cell which is not a platform cell or a tunnel cell.

According to an embodiment of the invention, if there is a neighbor cell, the UE 110 may restrain the serving cell from switching from the platform cell to the neighbor cell when at least one condition is met. That is, when the condition(s) is met, the quality of the current serving cell (i.e., platform cell) is good enough. Therefore, the UE 110 may restrain the serving cell from switching from the platform cell to the neighbor cell to maintain the high throughput and capacity of the current serving cell. When the condition is not met (i.e., the quality of the current platform cell is not good enough), the UE 110 may perform the normal cell switching.

In an example, the condition(s) for restraining the serving cell from switching from the platform cell to the neighbor cell may comprise that the number of MIMO layers is higher than or equal to a first value (e.g., 2), the carrier bandwidth is larger than or equal to a second value (e.g., 100), the ss-PBCH-BlockPower is higher than a third value (e.g., 15), the RSRP exceeds a first threshold (e.g., −400), the SINR exceeds a second threshold (e.g., 0), the Rx quality level exceeds a third threshold (e.g., 1), or any combination thereof.

In the embodiment, the UE 110 may further determine whether the neighbor cell is a known cell or an unknown cell. When the neighbor cell is a known cell (e.g., a known tunnel cell), the UE 110 may set a first threshold (e.g., 15 dB) for the RSRP difference between the serving cell and the neighbor cell (i.e., the RSRP of neighbor cell-the RSRP of serving cell) to restrain the serving cell from switching from the platform cell to the neighbor cell., and when the neighbor cell is an unknown cell, the UE 110 may set a second threshold (e.g., 10 dB) for the RSRP difference between the serving cell and the neighbor cell to restrain the serving cell from switching from the platform cell to the neighbor cell. Specifically, when the neighbor cell is a known cell and the RSRP difference between the serving cell and the neighbor cell is smaller than the first threshold, the UE 110 may restrain the serving cell from switching from the platform cell to the neighbor cell. Accordingly, when the neighbor cell is an unknown cell and the RSRP difference between the serving cell and the neighbor cell is smaller than the second threshold, the UE 110 may restrain the serving cell from switching from the platform cell to the neighbor cell.

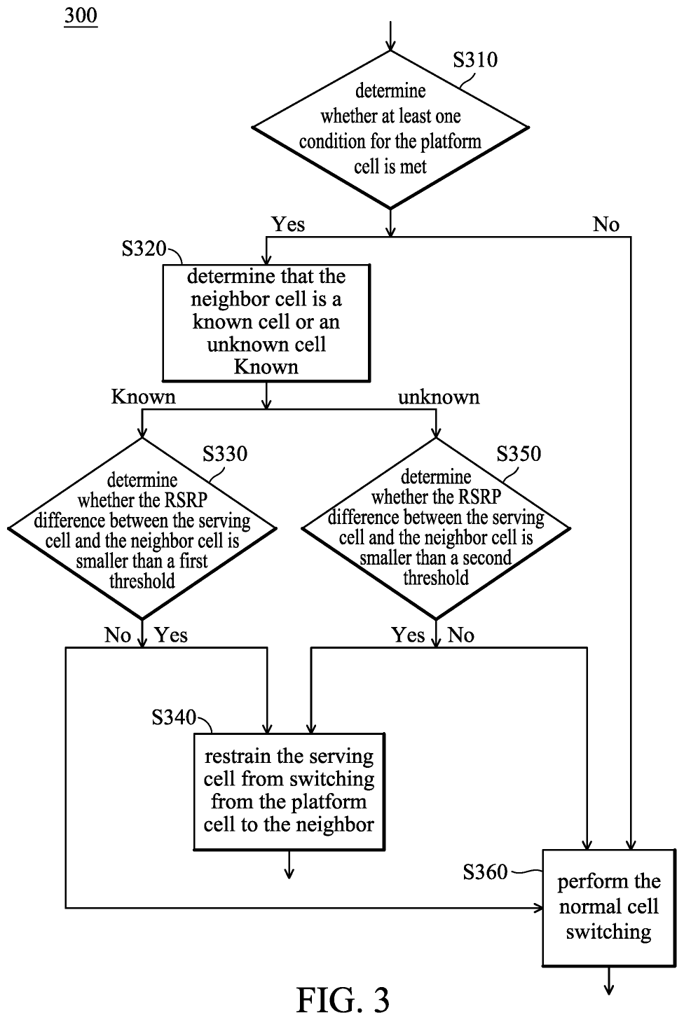

FIG. 3 is a flow chart illustrating a method 300 for restraining from switching to a neighbor cell according to an embodiment of the invention. The method 300 may be applied to UE 110. As shown in FIG. 3, in step S310, when the serving cell is platform cell and there is a neighbor cell, the UE 110 may determine whether at least one condition for the platform cell is met. If the condition is not met, step S360 is performed. In step S360, the UE 110 may perform the normal cell switching.

If the condition is met, step S320 is performed. In step S320, the UE 110 may determine that the neighbor cell is a known cell or an unknown cell. In another embodiment, in step S320, the UE 110 may directly restrain the serving cell from switching from the platform cell to the neighbor cell, i.e., the UE 110 may not further determine that the neighbor cell is a known cell or an unknown cell.

If the neighbor cell is a known cell, step S330 is performed. In step S330, the UE 110 may determine whether the RSRP difference between the serving cell and the neighbor cell (i.e., the RSRP of neighbor cell-the RSRP of serving cell) is smaller than a first threshold (e.g., 15 dB). If the RSRP difference between the serving cell and the neighbor cell is smaller than the first threshold, step S340 is performed. In step S340, the UE 110 may restrain the serving cell from switching from the platform cell to the neighbor cell. If the RSRP difference between the serving cell and the neighbor cell is not smaller than the first threshold, step S360 is performed.

If the neighbor cell is an unknown cell, step S350 is performed. In step S350, the UE 110 may determine whether the RSRP difference between the serving cell and the neighbor cell is smaller than a second threshold (e.g., 10 dB). If the RSRP difference between the serving cell and the neighbor cell is smaller than the second threshold, step S340 is performed. If the RSRP difference between the serving cell and the neighbor cell is not smaller than the second threshold, step S360 is performed.

According to an embodiment of the invention, if there is a neighbor cell, the UE 110 may restrain the serving cell from switching from the tunnel cell to the neighbor cell when at least one condition is met. When the current serving cell is a tunnel cell, it means that the UE 110 may be in a high-speed moving environment. Therefore, when the quality of the current tunnel cell is good enough, the UE 110 may restrain the serving cell from switching from the tunnel cell to the neighbor cell to make the UE 110 be able to camp on the current tunnel cell without switching to a history tunnel cell or a prior tunnel cell to reduce the ping-pong effect. When the condition is not met (i.e., the quality of the current tunnel cell is not good enough), the UE 110 may perform the normal cell switching.

In an example, the condition(s) for restraining the serving cell from switching from the tunnel cell to the neighbor cell may comprise that the neighbor cell is another tunnel cell, the number of MIMO layers is higher than or equal to a first value, the RSRP exceeds a first threshold, the SINR exceeds a second threshold, or any combination thereof.

In the embodiment, when the serving cell is a tunnel cell and there is a neighbor cell, the UE 110 may further set an offset of the neighbor cell by adding a value (e.g., −5 dB) to the default offset (e.g., cellIndividualOffset) of the neighbor cell to restrain the serving cell from switching from the tunnel cell to the neighbor cell.

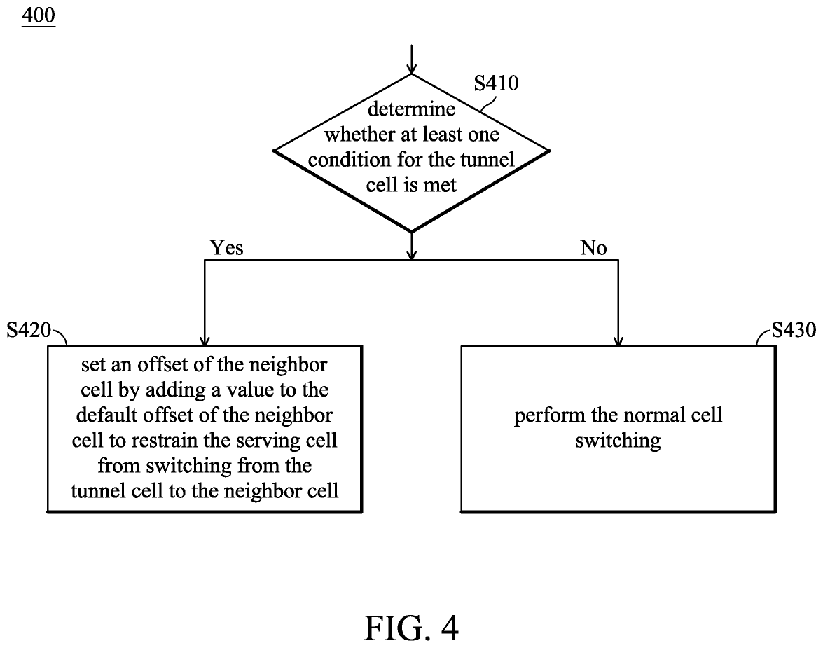

FIG. 4 is a flow chart illustrating a method 400 for restraining from switching to a neighbor cell according to another embodiment of the invention. The method 400 may be applied to UE 110. As shown in FIG. 4, in step S410, when the serving cell is tunnel cell and there is a neighbor cell, the UE 110 may determine whether at least one condition for the tunnel cell is met.

If the condition is met, step S420 is performed. In step S420, the UE 110 may set an offset of the neighbor cell by adding a value (e.g., −5 dB) to the default offset (e.g., cellIndividualOffset) of the neighbor cell to restrain the serving cell from switching from the tunnel cell to the neighbor cell. In another embodiment, in step S420, the UE 110 may directly restrain the serving cell from switching from the tunnel cell to the neighbor cell without adjusting the default offset of the neighbor cell.

If the condition is not met, step S430 is performed. In step S430, the UE 110 may perform the normal cell switching.

According to an embodiment of the invention, the UE 110 may determine whether the neighbor is a platform cell when the serving cell is the tunnel cell. When the UE 110 determines that the neighbor cell is a platform cell (i.e., the UE 110 will move from the tunnel to the platform), the UE 110 may switch the serving cell from the tunnel cell to the platform cell.

In the embodiment, when the neighbor cell is a platform cell, the UE 110 may further set an offset of the neighbor cell by subtract a value (e.g., −8 dB) from the default offset (e.g., cellIndividualOffset) of the neighbor cell to increase the opportunity of switching from the tunnel cell to the platform cell.

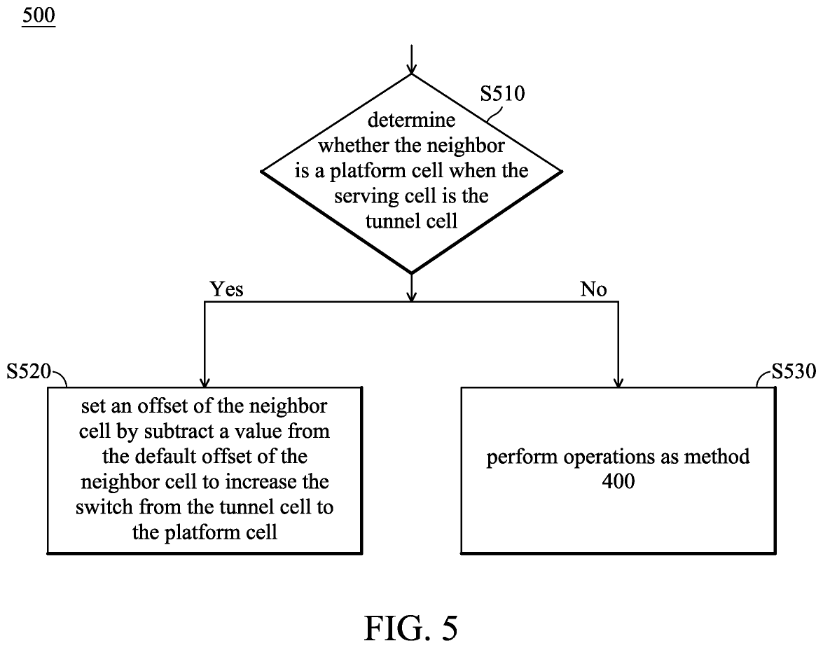

FIG. 5 is a flow chart illustrating a method 500 for switching from a tunnel cell to a platform cell according to an embodiment of the invention. The method 500 may be applied to UE 110. As shown in FIG. 5, in step S510, the UE 110 may determine whether the neighbor cell is a platform cell when the serving cell is the tunnel cell.

When the UE 110 determines that the neighbor cell is a platform cell, step S520 is performed. In step S520, the UE 110 may set an offset of the neighbor cell by subtract a value (e.g., −8 dB) from the default offset (e.g., cellIndividualOffset) of the neighbor cell to increase the opportunity of switching from the tunnel cell to the platform cell.

When the UE 110 determines that the neighbor cell is not a platform cell, step S530 is performed. If step S530, the UE 110 may perform operations as method 400.

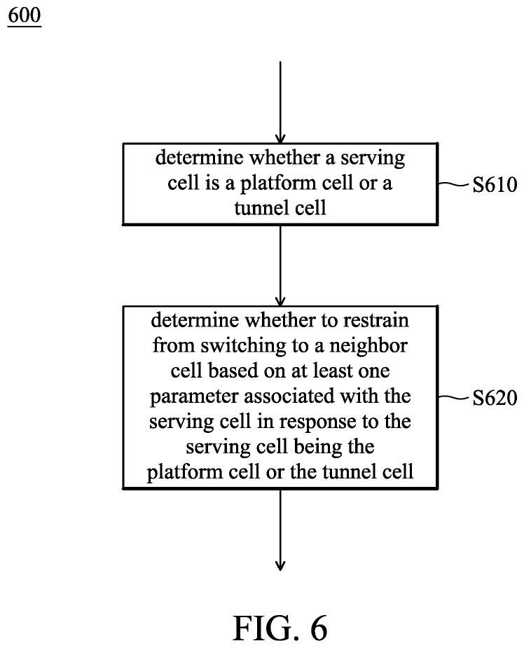

FIG. 6 is a flow chart illustrating a cell switching method 600 according to an embodiment of the invention. The method can be applied to the UE 110. As shown in FIG. 6, in step S610, a processor of the UE 110 may determine whether a serving cell is a platform cell or a tunnel cell.

In step S620, the processor of the UE 110 may determine whether to restrain from switching to a neighbor cell based on at least one parameter associated with the serving cell in response to the serving cell being the platform cell or the tunnel cell.

According to an embodiment, in the cell switching method, the processor of the UE 110 may further determine that the serving cell is the platform cell in response to the number of multi-input multi-output (MIMO) layers being higher a first value, a synchronization signal (ss)-physical broadcast channel (PBCH)-BlockPower being lower than or equal to 5 and the serving cell having a lower variance.

According to an embodiment, in the cell switching method, the processor of the UE 110 may further determine that the serving cell is the tunnel cell in response to the number of MIMO layers being lower than or equal to the first value, the ss-PBCH-BlockPower being higher than or equal to 0 and the serving cell having a higher variance.

According to an embodiment, in the cell switching method, the serving cell having a lower variance may mean that the reference signal received power (RSRP) variance (VAR) of the serving cell is smaller than a first threshold (e.g., 7) and the Doppler value of the serving cell is smaller than a second threshold (e.g., 0), and wherein the serving cell having a higher variance may mean that the RSRP VAR of the serving cell is larger than a third threshold (e.g., 7) and the Doppler value of the serving cell is larger than a fourth threshold (e.g., 0).

According to an embodiment, in the cell switching method, the processor of the UE 110 may further determine that the UE 110 enters a subway mode in response to the serving cell being switched to the platform cell or the tunnel cell, and determine that the UE 110 leaves the subway mode in response to the serving cell being switched to a cell from the platform cell or the tunnel cell, wherein the cell is not the platform cell or the tunnel cell.

According to an embodiment, in the cell switching method, the at least one parameter may comprise the number of MIMO layers, a carrier bandwidth, an ss-PBCH-BlockPower, an RSRP, a signal-to-interference-plus-noise ratio (SINR), and a reception (Rx) quality level.

According to an embodiment, in the cell switching method, the processor of the UE 110 may further restrain from switching from the platform cell to the neighbor cell in response to at least one condition being met, wherein the condition comprises that the number of MIMO layers is higher than or equal to a first value, the carrier bandwidth is equal to a second value, the ss-PBCH-BlockPower is higher than a third value, the RSRP exceeds a first threshold, the SINR exceeds a second threshold, and the Rx quality level exceeds a third threshold.

According to an embodiment, in the cell switching method, the processor of the UE 110 may further restrain from switching from the tunnel cell to the neighbor cell in response to at least one condition being met, wherein the condition comprises that the neighbor cell is another tunnel cell, the number of MIMO layers is higher than or equal to a value, the RSRP exceeds a first threshold, and the SINR exceeds a second threshold.

According to an embodiment, in the cell switching method, the processor of the UE 110 may further set a threshold for an RSRP difference between the serving cell and the neighbor cell (i.e., the RSRP of neighbor cell-the RSRP of serving cell), or set an offset of the neighbor cell to restrain from switching to the neighbor cell.

According to an embodiment, in the cell switching method, the processor of the UE 110 may further determine whether the neighbor is the platform cell in response to the serving cell being the tunnel cell, and switch the serving cell to the neighbor cell in response to the neighbor cell being the platform cell.

According to the cell switching method provided in the embodiments of the invention, the UE may perform cell selection more flexibility in the subway. In the cell switching method provided in the embodiments of the invention, the UE may further be able to maintain the high throughput and capacity when the UE in the platform of the subway. In addition, in the cell switching method provided in the embodiments of the invention, the UE may reduce the ping-pong elect when the UE in the tunnel of the subway.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A cell switching method, comprising:
determining, by a processor of a user equipment (UE), whether a serving cell is a platform cell or a tunnel cell; and
determining by the processor, whether to restrain the serving cell from switching to a neighbor cell based on at least one parameter associated with the serving cell in response to the serving cell being the platform cell or the tunnel cell.

2. The cell switching method of claim 1, further comprising:
determining, by the processor, that the serving cell is the platform cell in response to a number of multi-input multi-output (MIMO) layers being higher than a first value, a synchronization signal (ss)-physical broadcast channel (PBCH)-BlockPower being lower than or equal to 5 and the serving cell having a lower variance.

3. The cell switching method of claim 2, further comprising:
determining, by the processor, that the serving cell is the tunnel cell in response to the number of MIMO layers being lower than or equal to the first value, the ss-PBCH-BlockPower being higher than or equal to 0 and the serving cell having a higher variance.

4. The cell switching method of claim 3, wherein the serving cell having a lower variance means that a reference signal received power (RSRP) variance (VAR) of the serving cell is smaller than a first threshold and a Doppler value of the serving cell is smaller than a second threshold, and wherein the serving cell having a higher variance means that the RSRP VAR of the serving cell is larger than a third threshold and the Doppler value of the serving cell is larger than a fourth threshold.

5. The cell switching method of claim 1, further comprising:
determining, by the processor, that the UE enters a subway mode in response to the serving cell being switched to the platform cell or the tunnel cell; and
determining, by the processor, that the UE leaves the subway mode in response to the serving cell being switched to a cell from the platform cell or the tunnel cell, wherein the cell is not the platform cell or the tunnel cell.

6. The cell switching method of claim 1, wherein the at least one parameter comprises a number of MIMO layers, a carrier bandwidth, an ss-PBCH-BlockPower, an RSRP, a signal-to-interference-plus-noise ratio (SINR), and a reception (Rx) quality level.

7. The cell switching method of claim 6, further comprising:
restraining, by the processor, the serving cell from switching from the platform cell to the neighbor cell in response to at least one condition being met,
wherein the at least one condition comprises that the number of MIMO layers is higher than or equal to a first value, the carrier bandwidth is equal to a second value, the ss-PBCH-BlockPower is higher than a third value, the RSRP exceeds a first threshold, the SINR exceeds a second threshold, and the Rx quality level exceeds a third threshold.

8. The cell switching method of claim 6, further comprising:
restraining, by the processor, the serving cell from switching from the tunnel cell to the neighbor cell in response to at least one condition being met,
wherein the at least one condition comprises that the neighbor cell is another tunnel cell, the number of MIMO layers is higher than or equal to a value, the RSRP exceeds a first threshold, and the SINR exceeds a second threshold.

9. The cell switching method of claim 6, further comprising:
setting, by the processor, a threshold for an RSRP difference between the serving cell and the neighbor cell to restrain the serving cell from switching to the neighbor cell, or
setting an offset of the neighbor cell to restrain the serving cell from switching to the neighbor cell.

10. The cell switching method of claim 1, further comprising:
determining, by the processor, whether the neighbor is the platform cell in response to the serving cell being the tunnel cell; and
switching, by the processor, the serving cell to the neighbor cell in response to the neighbor cell being the platform cell.

11. A user equipment (UE) for cell switching, comprising:
a processor, determining whether a serving cell is a platform cell or a tunnel cell, and determining whether to restrain the serving cell from switching to a neighbor cell based on at least one parameter associated with the serving cell in response to the serving cell being the platform cell or the tunnel cell.

12. The UE of claim 11, wherein the processor determines that the serving cell is the platform cell in response to a number of multi-input multi-output (MIMO) layers being higher than a first value, a synchronization signal (ss)-physical broadcast channel (PBCH)-BlockPower being lower than or equal to 5 and the serving cell having a lower variance.

13. The UE of claim 12, wherein the processor determines that the serving cell is the tunnel cell in response to the number of MIMO layers being lower than or equal to the first value, the ss-PBCH-BlockPower being higher than or equal to 0 and the serving cell having a higher variance.

14. The UE of claim 13, wherein the serving cell having a lower variance means that a reference signal received power (RSRP) variance (VAR) of the serving cell is smaller than a first threshold and a Doppler value of the serving cell is smaller than a second threshold, and wherein the serving cell having a higher variance means that the RSRP VAR of the serving cell is larger than a third threshold and the Doppler value of the serving cell is larger than a fourth threshold.

15. The UE of claim 11, wherein the processor further determines that the UE enters a subway mode in response to the serving cell being switched to the platform cell or the tunnel cell, and determines that the UE leaves the subway mode in response to the serving cell being switched to a cell from the platform cell or the tunnel cell, wherein the cell is not the platform cell or the tunnel cell.

16. The UE of claim 11, wherein the at least one parameter comprises a number of MIMO layers, a carrier bandwidth, an ss-PBCH-BlockPower, an RSRP, a signal-to-interference-plus-noise ratio (SINR), and a reception (Rx) quality level.

17. The UE of claim 16, wherein the processor further restrains the serving cell from switching from the platform cell to the neighbor cell in response to at least one condition being met, wherein the at least one condition comprises that the number of MIMO layers is higher than or equal to a first value, the carrier bandwidth is equal to a second value, the ss-PBCH-BlockPower is higher than a third value, the RSRP is exceeds a first threshold, the SINR exceeds a second threshold, and the Rx quality level exceeds a third threshold.

18. The UE of claim 16, wherein the processor further restrains the serving cell from switching from the tunnel cell to the neighbor cell in response to at least one condition being met, wherein the at least one condition comprises that the neighbor cell is another tunnel cell, the number of MIMO layers is higher than or equal to a value, the RSRP exceeds a first threshold, and the SINR exceeds a second threshold.

19. The UE of claim 16, wherein the processor further sets a threshold for an RSRP difference between the serving cell and the neighbor cell, or sets an offset of the neighbor cell to restrain the serving cell from switching to the neighbor cell.

20. The UE of claim 11, wherein the processor further determines whether the neighbor is the platform cell in response to the serving cell being the tunnel cell, and switches the serving cell to the neighbor cell in response to the neighbor cell being the platform cell.
